(19) United States
(12) Patent Application Publication
(10) Pub. No.: US 2016/0097445 A1
(43) Pub. Date: Apr. 7, 2016

(54) LUBRICATION SYSTEM FOR TRANSFER CASE

(71) Applicant: BorgWarner Inc., Auburn Hills, MI (US)

(72) Inventor: Jesse Jongebloed, Clawson, MI (US)

(21) Appl. No.: 14/839,362

(22) Filed: Aug. 28, 2015

Related U.S. Application Data
(60) Provisional application No. 62/058,149, filed on Oct. 1, 2014.

(51) Int. Cl. F16H 57/04; B60K 17/344

(52) U.S. Cl. CPC F16H 57/043; F16H 57/0468; F16H 57/0436; F16H 57/0471; B60K 17/344

(57) ABSTRACT

A lubrication system (200) for a transfer case (120) includes a shaft (210) having a lubricant supply port (214); a control collar (230) disposed on the shaft (210), the control collar (230) having at least one lubrication path (234); and an actuator (250) for moving the control collar (230) between a first position in which lubricant is able to flow from the lubricant supply port (214) through the at least one lubrication path (234) and a second position in which lubricant is not able to flow from the lubricant supply port (214) through the at least one lubrication path (234).

### CROSS-REFERENCE TO RELATED APPLICATIONS

This application claims the benefit of U.S. Provisional Application No. 62/058,149, which was filed on Oct. 1, 2014.

### BACKGROUND

In the field of vehicle drivetrain components, a transfer case is an apparatus that distributes driving power to more than one driven axle of the vehicle. A typical transfer case receives driving power from the transmission of the vehicle and transfers that power to a primary output shaft and a secondary output shaft, with the secondary output shaft being driven selectively using a clutch. In addition, two speed transfer cases provide gear reduction to allow operation in a high range, which is typically a 1:1 drive ratio, or a low range, such as a 2:1 drive ratio.

Many of the components in a transfer case require lubrication. One transfer case design includes a pump that is mounted on one of the input shaft or the primary output shaft. The pump delivers lubricant to the various components of the transfer case through an axial bore that is formed through the input shaft and/or the output shaft. Supply ports are formed through the input shaft and/or the output shaft at locations where lubrication is needed, such that the lubricant flows from the pump, through the axial bore, and out of the supply ports. This arrangement is effective but offers little control over the rate of lubricant flow to specific components.

### SUMMARY

One aspect of the disclosed embodiments is a lubrication system for a transfer case includes a shaft having a lubricant supply port, a control collar disposed on the shaft, and an actuator. The control collar has at least one lubrication path. The actuator moves the control collar between a first position in which lubricant is able to flow from the lubricant supply port through the at least one lubrication path and a second position in which lubricant is not able to flow from the lubricant supply port through the at least one lubrication path.

Another aspect of the disclosed embodiments is a transfer case for a vehicle. The transfer case includes a primary shaft assembly having an input shaft and a primary output shaft. The primary shaft assembly has a hollow bore, at least one input port in communication with the hollow bore, and at least one outlet port in communication with the hollow bore. The transfer case also includes a secondary output shaft and a clutch that is operable to transfer power from the primary shaft assembly to the secondary output shaft when the clutch is in an engaged position. A pump is disposed on the primary shaft assembly for supplying a lubricant to the hollow bore via the at least one input port. A control collar is disposed on the primary shaft assembly. The control collar has at least one lubrication path. The transfer case also includes a selector fork for moving the control collar between a first position in which a lubricant is able to flow from the at least one outlet port to the clutch through the at least one lubrication path and a second position in which the lubricant is not able to flow from the at least one outlet port to the clutch through the at least one lubrication path. A barrel cam is operable to cause movement of the selector fork.

### BRIEF DESCRIPTION OF THE DRAWINGS

The description herein makes reference to the accompanying drawings, wherein like referenced numerals refer to like parts throughout several views, and wherein:

FIG. 1 is a plan view illustration showing a drivetrain that includes a transfer case;

FIG. 2 is a cross-section illustration showing a lubrication system according to a first example with a control collar in a first position;

FIG. 3 is a cross-section illustration showing the lubrication system of FIG. 2 with the control collar in a second position;

FIG. 4 is a cross-section view of a transfer case that includes a lubrication system according to a second example;

FIG. 5 is a detail view of the transfer case of FIG. 4 with a control collar of the lubrication system in a first position;

FIG. 6 is a detail view of the transfer case of FIG. 4 with the control collar of the lubrication system in a second position;

FIG. 7 is a perspective view showing the control collar of the lubrication system of FIG. 4; and

FIG. 8 is a front view showing the control collar of the lubrication system of FIG. 4.

### DETAILED DESCRIPTION

The disclosure herein is directed to a lubrication system for a transfer case in which lubricant can be routed toward or away from a particular component of the transfer case dependent on the operating mode of the transfer case. The lubrication system includes a control collar that manipulates a lubrication path between a pressurized lubricated shaft and the component by moving a port formed in the collar into and out of alignment with a lubricant supply port that is formed on the pressurized lubricated shaft.

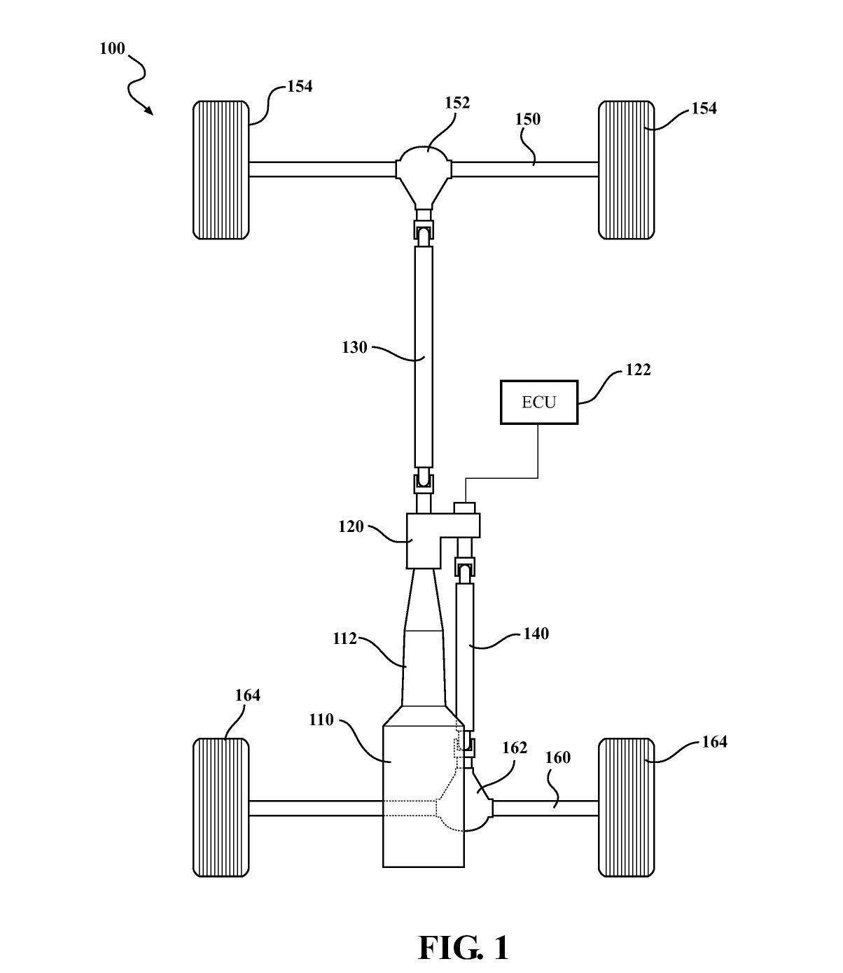

FIG. 1 shows a drivetrain 100 for a four-wheel drive vehicle. The drivetrain 100 includes an engine 110 that is coupled to a transmission 112. The engine 110 is the prime mover of the drivetrain 100 and can be, as examples, an internal combustion engine, an electric motor/generator, or a combination of the two. Other types of prime movers can be utilized as the engine 110 to provide driving power (e.g. via a rotating output shaft) to the transmission 112. The transmission 112 includes components operable to convert the speed and torque of the driving power provided by the engine 110, such as by a gear train that provides multiple gear ratios. As examples, the transmission 112 can be a manual transmission, an automatic transmission, a semi-automatic transmission, a continuously variable transmission, or a dual clutch transmission.

The transmission 112 provides driving power to a transfer case 120. The transfer case 120 is operable to distribute driving power to a rear driveshaft 130 and a front driveshaft 140.

The transfer case 120 can, in some implementations, include components that allow the transfer case to perform a mode shift between two or more different modes. For example, the transfer case 120 can allow operation in a rear-wheel drive mode, in which the rear driveshaft 130 receives driving power and the front driveshaft 140 does not, and a four-wheel drive mode, in which the rear driveshaft 130 and the front driveshaft 140 both receive driving power. In this example, the rear driveshaft 130 is the primary driveshaft and the front driveshaft 140 is the secondary driveshaft. In other implementations, the front driveshaft 140 is the primary driveshaft and the rear driveshaft 130 is the secondary driveshaft, and the transfer case 120 performs a mode shift between a front-wheel drive mode and a four-wheel drive mode. In other implementations the transfer case 120 does not include components that allow a mode shift, and the transfer case 120 constantly provides driving power to both of the rear driveshaft 130 and the front driveshaft 140.

The transfer case 120 can allow a range shift that selectively provides gear reduction to the rotational output of the transfer case 120. For example, the transfer case can include components for operating in a high range, such as a 1:1 drive ratio, or a low range, such as a 2:1 drive ratio. The range shift changes the transfer case 120 between operation in the low range and the high range by selectively coupling and uncoupling a gear reduction mechanism of the transfer case 120.

Operation of the transfer case 120 can be regulated by a controller such as an electronic control unit (ECU) 122 that provides signals to components of the transfer case 120 to cause the mode shift and/or the range shift. In other implementations, the mode shift and/or the range shift can be actuated mechanically such as by a driver-operated lever that is mechanically connected to a component of the transfer case 120.

The rear driveshaft 130 provides driving power to a rear axle 150 via a rear differential 152. The rear axle 150 can be, as examples, a solid axle or a pair of independent half axles. The rear axle 150 provides driving power to a pair of rear wheels 154 that are fitted with tires.

The front driveshaft 140 provides driving power to a front axle 160 via a front differential 162. The front axle 160 can be, as examples, a solid axle or a pair of independent half axles. The front axle 160 provides driving power to a pair of front wheels 164 that are fitted with tires.

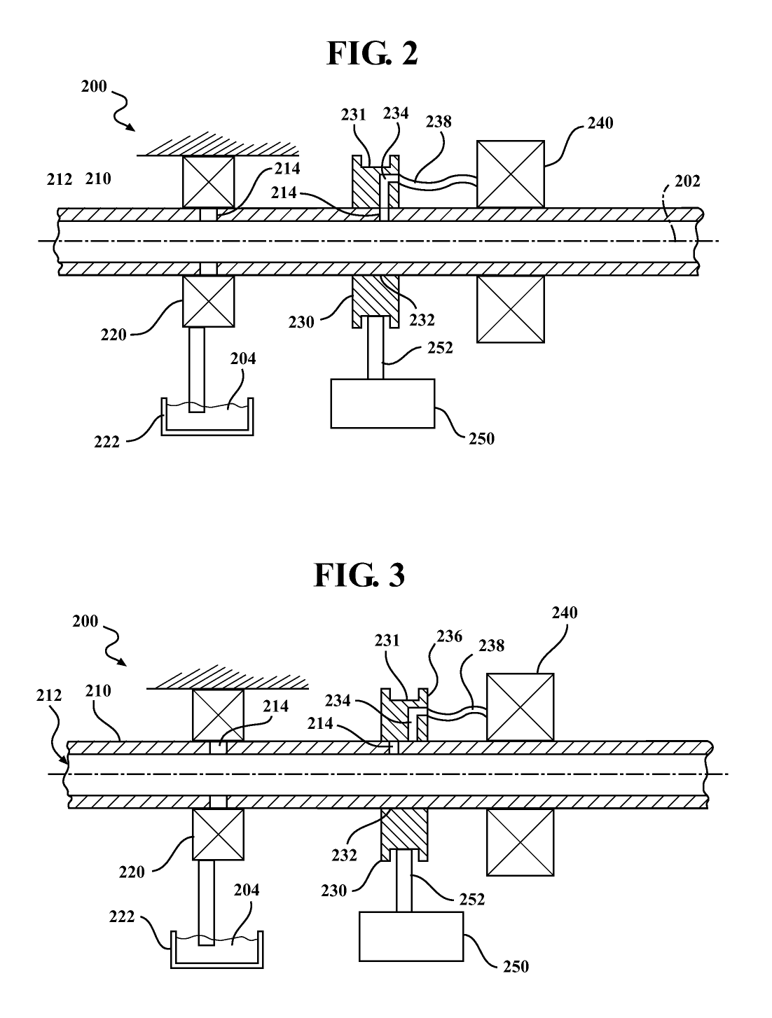

FIGS. 2-3 show a lubrication system 200 for a transfer case that can be incorporated, for example, in the transfer case 120. The lubrication system 200 includes a shaft 210 that extends along a longitudinal axis 202. The shaft 210 is a rotating shaft that rotates on the longitudinal axis 202 in response to an externally-applied rotational force.

The shaft 210 has a hollow bore 212 and a plurality of lubricant supply ports 214. The hollow bore 212 extends along the longitudinal axis 202. During operation of the lubrication system 200, the hollow bore 212 of the shaft 210 is utilized to carry a lubricant 204 under pressure to components that are disposed on the shaft 210. The lubricant 204 enters and exits the hollow bore 212 of the shaft 210 through the lubricant supply ports 214. The lubricant supply ports 214 are holes that extend through the shaft 210. For example, the lubricant supply ports 214 can extend radially through the shaft 210 from the hollow bore 212 to an exterior surface of the shaft 210.

The lubrication system 200 includes a pump 220 that receives a rotational input force that drives a pumping mechanism (not shown). The pumping mechanism is in fluid communication with a source of the lubricant 204, such as a sump 222, and supplies the lubricant 204 under pressure to the hollow bore 212 of the shaft 210 through one of the lubricant supply ports 214. In the illustrated example, the pump 220 is arranged on the shaft 210 such that a portion of the shaft 210 extends through the pump 220, in what is known as an on-axis design. At least a portion of the pumping mechanism of the pump 220 is fixed to the shaft 210 for rotation in unison with the shaft 210 in order to drive the pumping mechanism. At the same time, another portion of the pump 220 remains fixed, such as a housing of the pump 220 being secured to the housing of the transfer case in which the lubrication system 200 is installed.

The lubrication system 200 includes a control collar 230. The control collar 230 is a circular, disk-like body that is located on the shaft 210. For example, the control collar 230 can be disposed on the shaft 210 with an axis of the circular shape of the control collar 230 being aligned with the longitudinal axis 202.

The control collar 230 has an axial bore 232. The shaft 210 passes through the axial bore 232 of the control collar 230. In some implementations, the axial bore 232 of the control collar 230 is seated directly on the shaft 210. In other implementations, a separate component is disposed between the axial bore 232 of the control collar 230 and the shaft 210. In such an implementation, the lubricant supply port 214 that supplies the lubricant 204 to the control collar 230 is aligned with and supplies the lubricant through a port formed through the separate component. The control collar 230 can be fixed for rotation with the shaft 210, such as by splines, or may be free of a rotational coupling to the shaft 210, such that the control collar 230 remains fixed rotationally when the shaft 210 rotates with respect to it.

One or more lubrication paths 234 extend through the control collar 230 for conducting the lubricant 204 through the control collar from a first end of each of the lubrication paths 234 to a second end of each of the lubrication paths 234. The first end of each lubrication path 234 is formed on the axial bore 232 of the control collar 230. The second end of each lubrication path 234 can be formed on a radial face 236 of the control collar 230, with the radial face 236 extending perpendicular to the longitudinal axis 202. The lubricant 204 that flows through the one or more lubrication paths of the control collar 230 is provided to a component 240, which can be arranged on the shaft 210. In some implementations the lubricant 204 enters an additional lubrication path 238 such as a conduit upon exiting the second end of the respective one of the lubrication paths 234, and flows through the additional lubrication path 238 to the component 240.

The component 240 can be any portion of a transfer case that requires lubrication, such as a clutch, a sprocket, a chain, a gear, or a bearing. The component 240 can be fixed on the shaft for rotation with the shaft 210, can be free of rotational connection to the shaft 210, or can have a clutched connection to the shaft 210 for rotation with the shaft when the clutched connection is engaged. The component 240 and the control collar 230 can have the same type of rotational relationship with the shaft 210. For example, in an implementation where the component selectively rotates with the shaft 210 such as by a clutched connection to the shaft 210, the control collar 230 can be fixed for rotation in unison with the component 240. In alternative implementations, the control collar 230 and the component 240 can have different rotational relationships with respect to the shaft 210, in which case the additional lubrication path can be configured to accommodate rotation, such as by including a sleeve that is located on the shaft 210 and includes a rotary joint.

The lubrication system 200 includes an actuator 250 for moving the control collar 230 relative to the shaft 210. The actuator 250 can cause motion of the control collar 230, for example, responsive to signals received from a controller such as the ECU 122.

By moving the control collar 230 relative to the shaft 210, the control collar 230 can be positioned such that the first end of the lubrication path 234 is either aligned with the lubricant supply port 214 of the shaft 210 or is not aligned with the lubricant supply port 214 of the shaft 210. When the first end of the lubrication path 234 is aligned with the lubricant supply port 214 of the shaft, the lubricant 204 flows from the lubricant supply port 214 into and through the lubrication path 234 under pressure from the pump 220. When the first end of the lubrication path 234 is not aligned with the lubricant supply port 214 of the shaft, a solid surface of the control collar 230 is instead positioned adjacent to the lubricant supply port 214, and the control collar 230 thus impedes flow of the lubricant 204 from the lubricant supply port 214. Thus, the flow of the lubricant 204 via the lubrication path is partially or entirely disrupted.

At least a portion 252 of the actuator 250 is engaged with the control collar 230. The portion 252 is moved by the actuator 250, such as by an electric motor included in then actuator. For example, the actuator 250 can include a movable selector fork as the portion 252, which is engaged with the control collar 230, such as by being seated in an annular groove 231 that is formed on an outer periphery of the control collar 230.

In the illustrated example, the control collar 230 is moved by the actuator 250 axially along the shaft 210 between a first position (FIG. 2) and a second position (FIG. 3) In the first position, the lubricant supply port 214 is aligned with the first end of the lubrication path 234 to allow a flow of the lubricant 204 from the lubricant supply port 214 through the lubrication path 234. In the second position, the lubricant supply port 214 is not aligned with the first end of the lubrication path 234. In the illustrated example, the flow of the lubricant 204 from the lubricant supply port 214 is impeded by the control collar 230 in the second position. In an alternative implementation, the control collar is spaced from the lubricant supply port in the second position, such as by being moved axially along the shaft 210, which causes the lubricant 204 from the lubricant supply port 214 adjacent to the control collar 230 to vent to the sump 222. In another implementation, the first position remains the same, the control collar impedes flow of the lubricant 204 in the second position, and the control collar 230 is moved away from the lubricant supply port 213 in a third position.

In an alternative example, the control collar 230 can be rotated by the actuator 250 between the first and second positions selectively to permit or restrict flow of the lubricant. In this example, instead of a selector fork, the portion 252 can be a gear, a belt or other device that is operable to rotate the control collar 230.

Other types of actuators can be utilized, including actuators that do not require external control signals, such as signals from the ECU 122. In implementations where the component 240 is clutched to the shaft 210 and the control collar rotates in unison with the component 240, the actuator can be a centrifugally-actuated device that causes the control collar 230 to shift axially on the shaft 210 between the first and second positions when the component 240 starts or stops rotating.

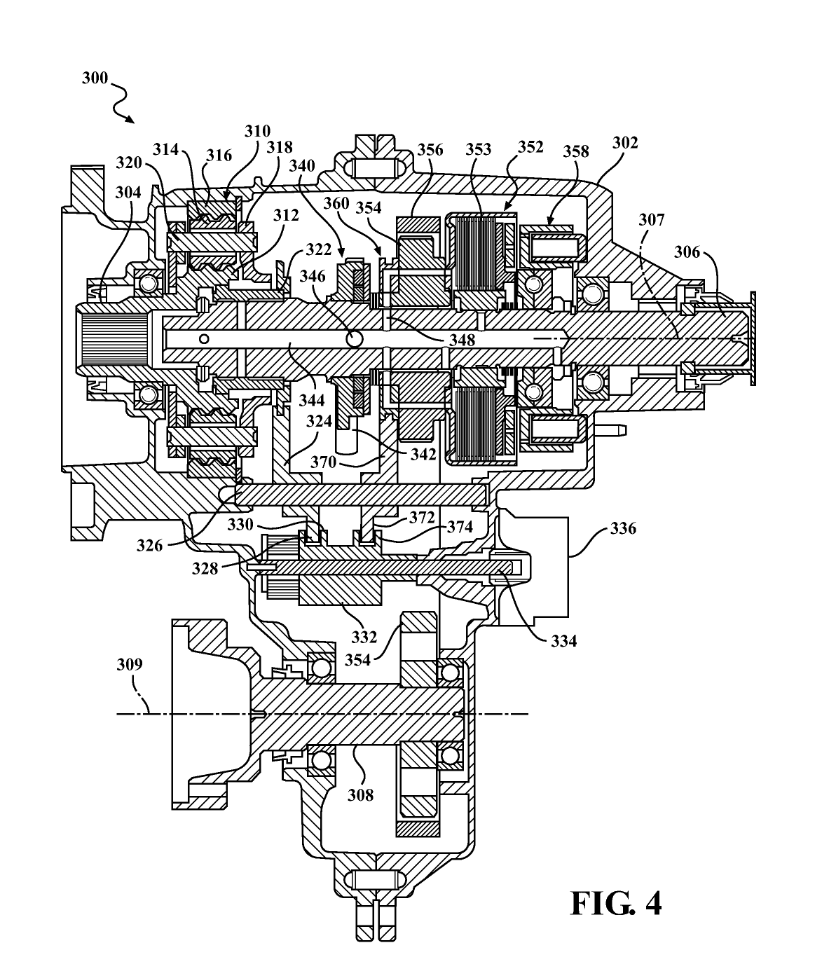

FIG. 4 shows a transfer case 300. The transfer case 300 includes a housing 302, a primary shaft assembly defined by an input shaft 304 that extends out of the housing 302 and a primary output shaft 306 that extends out of the housing 302, and a secondary output shaft 308 that extends out of the housing 302. The input shaft 304 and the primary output shaft 306 extend along a first axis 307. The secondary output shaft 308 extends along a second axis 309 which is, in this example, parallel to the first axis 307.

The input shaft 304 is at least partially hollow, and the primary output shaft 306 extends into the hollow interior of the input shaft 304. The input shaft 304 can be connected to the primary output shaft either directly, or via a gear reduction mechanism 310. The gear reduction mechanism 310 can be a Ravigneaux planetary gearset that includes a sun gear 312 formed on the input shaft 304, a plurality of planet gears 314, and a ring gear 316 that is fixed t the housing 302. A planet carrier 318 is arranged on the input shaft 304 and can rotate about the input shaft 304. The planet gears 314 are arranged on stub shafts 320 that are connected to the planet carrier 318. The planet gears 314 mesh with the sun gear 312 and the ring gear 316.

A dog clutch 322 is utilized to engage and disengage the gear reduction mechanism 310. In a first position of the dog clutch 322, the dog clutch 322 engages the input shaft 304 and the primary output shaft 306 directly, which establishes a 1:1 drive ratio and does not utilize the gear reduction mechanism 310. In a second position of the dog clutch 322 (not shown) the dog clutch 322 is shifted axially away from the input shaft 304, and instead engages the planet carrier 318 and the primary output shaft 306. Driving power is thus routed through the gear reduction mechanism 310, with the planet carrier rotating slower to than the input shaft 304 to establish a drive ratio such as 2:1.

The dog clutch 322 is moved between its first and second positions by a first selector fork 324 which moves axially along a selector shaft 326. A first cam follower 328 is formed on the first selector fork 324. The first cam follower 328 is disposed in a first groove 330 formed on an exterior surface of a barrel cam 332. The barrel cam 332 is disposed on a rotatable shaft 334 that is rotated be an electric motor 336 in response to control signals from a controller such as the ECU 122 of FIG. 1.

The transfer case 300 includes a pump 340 for pumping a lubricant (not shown) to components of the transfer case 300 that require lubrication. The pump 340 is arranged on the primary output shaft 306 and a pump mechanism of the pump 340 is driven by the primary output shaft 306. The pump 340 can be, for example, a gerotor pump. Other types of pumping mechanisms can be utilized. At least a portion of the housing 302 can serve as a sump, and the pump 340 can include a conduit 342 that extends into the sump area of the housing 302.

To route lubrication to various components of the transfer case 300, the primary output shaft includes an axially extending hollow bore 344 and a plurality of lubricant ports that extends radially through the primary output shaft 306 and are in communication with the hollow bore 344, including an inlet port 346 and one or more outlet ports 348. The inlet port 346 is aligned with the pump 340 and received the lubricant under pressure from the pump 340. The outlet ports 348 are positioned along the primary output shaft 306 near components that require lubrication. The lubricant is pressurized by the pump 340, travels through the inlet port 346, along the hollow bore 344, and out of one of the outlet ports 348 to lubricate portions of the transfer case 300. Excess lubricant then drains to the sump area inside the housing 302.

A first sprocket 350 is arranged on the primary output shaft 306 and is connected to the primary output shaft by a clutch 352. A second sprocket 354 is arranged on the secondary output shaft 308 and connected for rotation in unison, such as by splines. The first sprocket 350 and the second sprocket 354 are connected by a chain 356, such that the second output shaft is driven by the primary output shaft 306 via the first sprocket 350, the chain 356 and the second sprocket 354 when the clutch 352 is engaged. The clutch 352 includes, for example, a clutch pack 353 of interleaved plates, with the clutch being engaged when pressure is applied to the clutch pack 353 by an electromagnetic actuator 358.

A control collar 360 is provided to permit or impede flow of the lubricant to the clutch pack 353. By permitting or impeding flow of the lubricant, the amount of lubricant that is provided to the clutch pack 353 can be varied based on the operating state and/or operating conditions of the clutch pack 353. For example, lubricant flow can be permitted when the clutch 352 is engaged, and lubricant flow can be impeded by the control collar 360 when the clutch 352 is disengaged, thereby reducing the amount of lubricant in the clutch pack 353, which decreases viscous drag in the clutch pack 353.

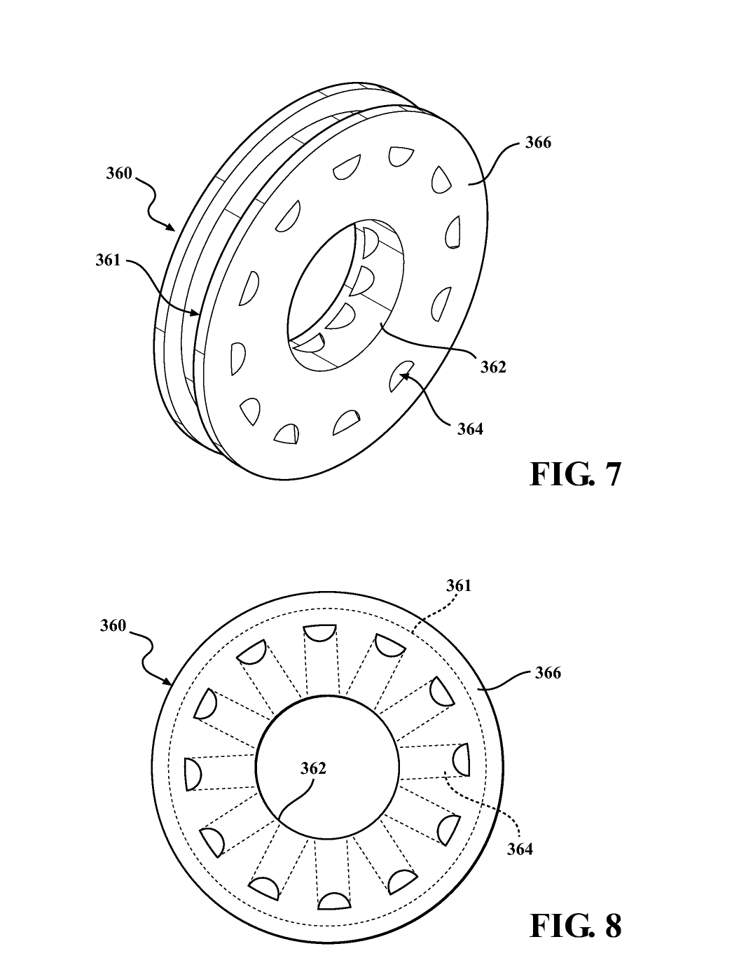

As best seen in FIGS. 7-8, the control collar 360 includes an annular grove 361, an axial bore 362, and a plurality of lubrication paths 364. The lubrication paths 364 each extend from a first end on the axial bore 362 to a second end on a radial face 366 of the control collar 360. In the illustrated example, the lubrication paths 364 include a 90 degree turn internal to the control collar 360. To simplify manufacturing of this component, the control collar 360 can be a two piece structure, with the lubrication paths being formed on an exterior surface of a disc-shaped insert that is received in an opening in a second part. The two parts can then be fastened together in any suitable way such as by brazing.

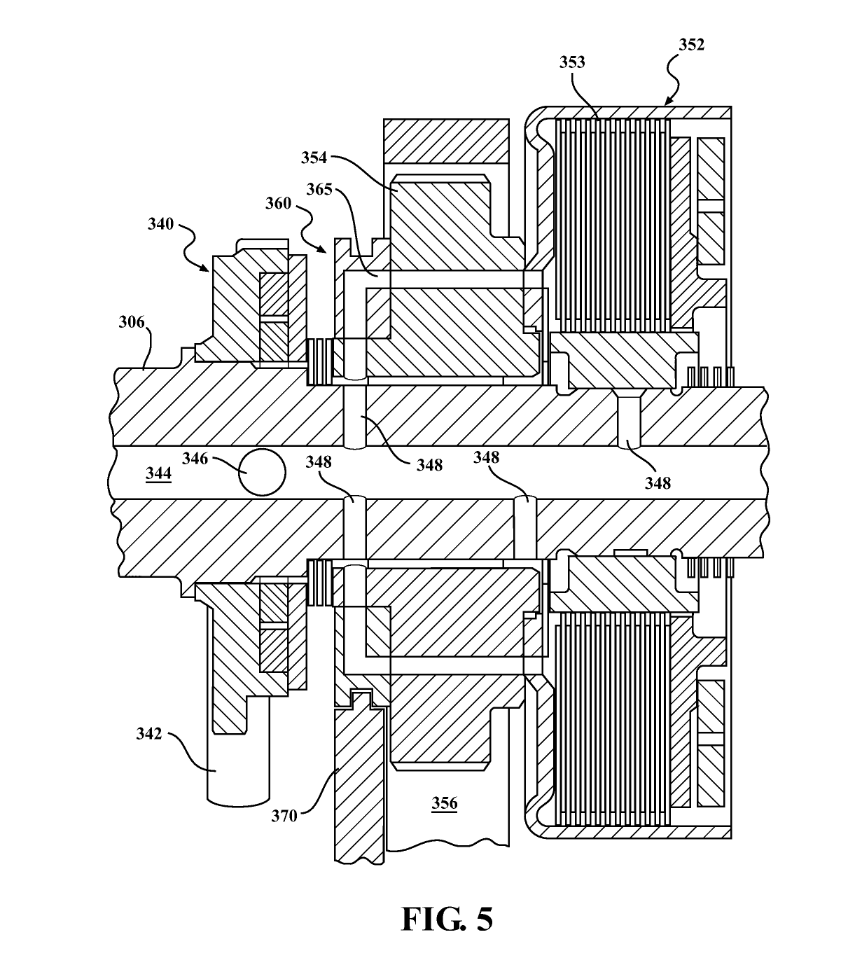

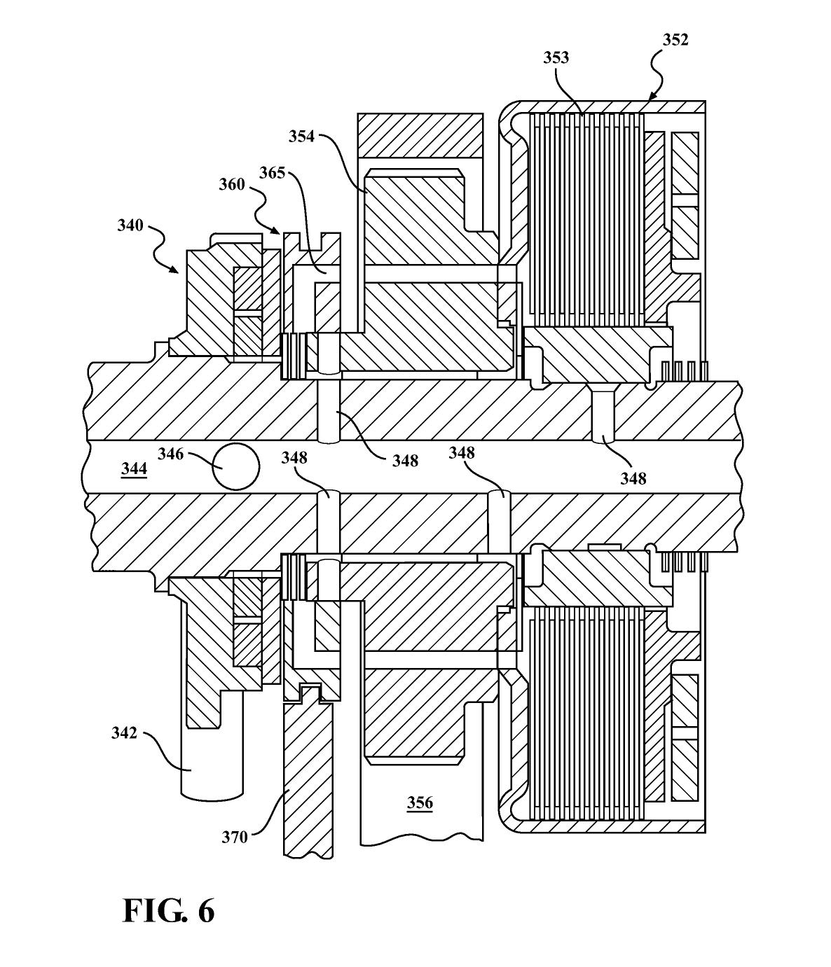

With further reference to FIGS. 3-6, the control collar 360 is movable axially with respect to the primary output shaft 306 between a first position (FIG. 4) and a second position (FIG. 5). In the first position, the first ends of the lubrication paths 364 are axially aligned with the outlet port 348 of the primary output shaft 306 to provide the lubricant to the lubrication paths 364. Because the lubricant is under pressure, it flows from the first ends of the lubrication paths 364 at the axial bore 362 to the second ends of the lubrication paths 364 at the radial face 366 of the control collar 360.

In second first position, the second ends of the lubrication paths 364 are not axially aligned with the outlet port 348 of the primary output shaft 306. Instead, misalignment of the lubrication paths 364 with respect to the outlet port 348 impedes or stops the flow of lubricant from the outlet port 348 to the lubrication paths 364.

When the control collar 360 is in the first position, the second ends of the lubrication paths 364 can be aligned with ports 368 that extend through the second sprocket 354 axially in order to deliver the lubricant to the clutch pack 353. Holes can be formed through the plates in the clutch pack in radial alignment with the ports 368 in order to distribute the lubricant through the clutch pack 353.

As similarly described with respect to the lubrication system 200, an alternative second position moves the control collar 360 away from the outlet port 348 to vent lubricant to the sump of the transfer case 300, and this position can instead be adopted as a third position to allow additional control over lubrication within the transfer case.

The control collar 360 can be moved between the first position and the second position by an actuator such as a second selector fork 370 that moves responsive to rotation of the barrel cam 332. The second selector fork 370 includes a cam follower 372 that is engaged with and follows a second groove 374 in the barrel cam 332. The second groove 374 and the first groove 330 can be separate structures or portions of the same groove. In either case, the barrel cam 332 can be configured such that the first selector fork 324 and the second selector fork 370 do or do not move in unison, as desired. Alternatively, a second, independent barrel cam could be provided. Other actuators could be used to move the control collar.

In operation, a transfer case is operable to shift between a first mode and a second mode, and optionally, between a first range and a second range. A control collar is provided on a pressurized lubricated shaft to control the flow of lubricant to a component, such as a clutch, dependent upon the mode and/or range of the transfer case. Other factors can be utilized to control actuation of the control collar, such as speed.

While the disclosure has been made in connection with what is presently considered to be the most practical and preferred embodiment, it should be understood that the disclosure is intended to cover various modifications and equivalent arrangements.

1. A lubrication system (200) for a transfer case (120), comprising:
a shaft (210) having a lubricant supply port (214);
a control collar (230) disposed on the shaft (210), the control collar (230) having at least one lubrication path (234); and
an actuator (250) for moving the control collar (230) between a first position in which a lubricant (204) is able to flow from the lubricant supply port (214) through the at least one lubrication path (234) and a second position in which the lubricant (204) is not able to flow from the lubricant supply port (214) through the at least one lubrication path (234).

2. The lubrication system of (200) of claim 1, wherein the actuator (250) moves the control collar (230) axially along the shaft (210) between the first position and the second position.

3. The lubrication system (200) of claim 2, wherein the control collar (230) is mounted to the shaft (210) such that it rotates in unison with the shaft (210).

4. The lubrication system of (200) of claim 1, wherein the actuator (250) rotates the control collar (230) with respect to the shaft (210) between the first position and the second position.

5. The lubrication system (200) of claim 1, wherein the control collar (230) has an axial bore (232) and the control collar (230) is disposed on the shaft (210) such that the shaft (210) extends through the axial bore (232) of the control collar (230).

6. The lubrication system (200) of claim 5, wherein the control collar (230) has a radial face (236) and the at least one lubrication path (234) has a first end formed on the axial bore (232) and a second end formed on the radial face (236).

7. The lubrication system (200) of claim 6, wherein the lubricant supply port (214) is aligned with the first end of the lubrication path (234) when the control collar (230) is in the first position and the lubricant supply port (214) is not aligned with the first end of the lubrication path (234) when the control collar (230) is in the second position.

8. The lubrication system (200) of claim 7, wherein flow of the lubricant (204) from the lubricant supply port (214) is impeded by the control collar (230) when the control collar is in the second position.

9. The lubrication system (200) of claim 7, wherein the control collar (230) is spaced from the lubricant supply port (214) in the second position.

10. The lubrication system (200) of claim 1, further comprising:
a component (240) that is disposed on the shaft (210), wherein the lubricant (204) is able to flow from the lubrication path (234) to the component (240) when the control collar is in the first position.

11. The lubrication system (200) of claim 10, wherein the control collar (230) is mounted to the shaft (210) such that it rotates in unison with the component (240).

12. The lubrication system (200) of claim 10, wherein the component (240) is at least one of a clutch, a sprocket, a chain, a gear, or a bearing.

13. The lubrication system (200) of claim 1, wherein the actuator (250) includes a selector fork (370) that is engaged with the control collar (230) for moving the control collar (230) between the first position and the second position in response to movement of the selector fork (370).

14. The lubrication system (200) of claim 13, wherein the actuator (250) includes a barrel cam (332) that is operable to cause movement of the selector fork (370).

15. A transfer case (120, 300) for a vehicle, comprising:
a primary shaft assembly having an input shaft (304) and a primary output shaft (306), the primary shaft assembly having a hollow bore (344), at least one input port (346) in communication with the hollow bore (344), and at least one outlet port (348) in communication with the hollow bore (344);
a secondary output shaft (308);
a clutch (352) that is operable to transfer power from the primary shaft assembly to the secondary output shaft (308) when the clutch (352) is in an engaged position;
a pump (340) that is disposed on the primary shaft assembly for supplying a lubricant to the hollow bore (344) via the at least one input port (346);
a control collar (360) disposed on the primary shaft assembly, the control collar (360) having at least one lubrication path (364);
a selector fork (370) for moving the control collar (360) between a first position in which a lubricant (204) is able to flow from the at least one outlet port (348) to the clutch (352) through the at least one lubrication path (364) and a second position in which the lubricant (204) is not able to flow from the at least one outlet port (348) to the clutch (352) through the at least one lubrication path (364); and
a barrel cam (332) that is operable to cause movement of the selector fork (370).
